(19) United States
(12) Patent Application Publication
(10) Pub. No.: US 2024/0424892 A1
(43) Pub. Date: Dec. 26, 2024

(54) FUEL TANK FOR GAS-POWERED VEHICLE

(71) Applicant: VOITH PATENT GMBH, Heidenheim (DE)

(72) Inventors: Benedikt SCHLEIFER, Niederstotzingen (DE); Roland HOLZAPFEL, Schwäbisch Gmünd (DE)

(21) Appl. No.: 18/825,182

(22) Filed: Sep. 5, 2024

Related U.S. Application Data
(63) Continuation of application No. PCT/EP2023/054524, filed on Feb. 23, 2023.

(30) Foreign Application Priority Data
Mar. 8, 2022 (DE) 10 2022 105 364.4

(51) Int. Cl. B60K 15/07; B60K 15/03; B60K 15/063; F17C 13/08

(52) U.S. Cl. CPC B60K 15/07; F17C 13/084; B60K 2015/03032; B60K 2015/03493; B60K 15/063; F17C 2201/0109; F17C 2201/032; F17C 2205/0103; F17C 2221/012; F17C 2221/033; F17C 2223/036; F17C 2270/0171; F17C 2270/0184

(57) ABSTRACT

A fuel tank for storing a gas and for installation in a gas-powered vehicle, such as a utility vehicle. The fuel tank has an elongate cylindrical shape that is closed by curved pole caps at both ends, a reinforcing layer made of fiber-reinforced plastic, and a boss on each of the pole caps. The at least two fastening devices surround the cylindrical central part of the fuel tank with tensioning straps for fastening the fuel tank to a support structure. The cylindrical central region of the fuel tank has on the outer side thereof a bead, which is arranged directly adjacent to one of the fastening devices and abuts thereagainst so that the fuel tank is unable to slip through the tensioning strap(s) of this one fastening device at least in one direction.

### CROSS-REFERENCE TO RELATED APPLICATION

This application is a continuation, under 35 U.S.C. § 120, of copending International Patent Application PCT/EP2023/054524, filed Feb. 23, 2023, which designated the United States; this application also claims the priority, under 35 U.S.C. § 119, of German Patent Application DE 10 2022 105 364.4, filed Mar. 8, 2022; the prior applications are herewith incorporated by reference in their entirety.

### FIELD AND BACKGROUND OF THE INVENTION

The invention relates to a fuel tank for storing gas and for mounting in a gas-powered vehicle, in particular a utility vehicle. The fuel tank has an elongate shape which is cylindrical in the central region and is closed by curved pole caps at both ends, and a reinforcing layer made of fiber-reinforced plastic, and a metal connecting piece on each of the pole caps, known as a boss, and wherein the fuel tank has at least two fastening devices which surround the fuel tank with the aid of tensioning straps and are provided for fastening the fuel tank to a support structure.

The support structure serves for mounting the fuel tank to the vehicle chassis. Optionally a plurality of fuel tanks can also be fastened to a support structure and installed together as a tank module in the vehicle.

Gas-powered vehicles have, for example, a gas engine or a fuel cell with an electric motor as the drive. In order to be able to store sufficient fuel, the gas which can be hydrogen, among other things, is stored at high pressure in the tank. Pressures of over 200 bar, often up to 700 bar or 875 bar, are typical for such pressurized tanks. In other words, the fuel tank not only has to be gas-tight under this pressure but it also requires a high degree of mechanical stability. In addition, the fuel tank has to be of a sufficient size for utility vehicles and thus such fuel tanks are often more than 2 m (meters) long. In particular in the case of such long fuel tanks, the secure fastening to the vehicle is a challenging task since the fuel tanks have a significant weight and expand in the tank longitudinal direction in the event of corresponding internal pressure.

Fuel tanks for gas-powered vehicles are known in the prior art. These pressurized tanks have a wall which, for sealing purposes, comprises an internal liner which is made of thermoplastic, for example, and for creating the mechanical stability a reinforcing layer made of fiber-reinforced plastic. Preferably, the reinforcing layer is wrapped around and designed as a CFRP layer. CFRP stands for carbon fiber-reinforced plastic.

The boss has a through-bore and a connecting thread. In the installed state in the vehicle, a tank fitting which enables the pressurized tank to be filled or gas to be removed in a controlled manner is attached to at least one of the two bosses. On the other boss, the through-opening is sealed by a closure or a safety valve is provided therein.

As noted, fuel tanks for gas-powered vehicles are known from the prior art. A tank module with two fuel tanks is described, among other things, in German utility model DE 202007015487 U1. The two fuel tanks are clamped in each case at the two ends of the cylindrical central part to a support structure by a tensioning strap as a fastening device. A tensioning strap is wrapped in each case around two fuel tanks. The tank module is fastened to the vehicle chassis via the support structure. A tank fitting, via which the tanks are filled and emptied and which contains the necessary safety devices, is provided at one end of the fuel tank. In addition, there is a base which is adapted to the cross-sectional shape of the fuel tank and against which the fuel tank is pressed. However, clamping too tightly can damage the surface of the reinforcing layer.

Moreover, fuel tanks which are mounted vertically in the vehicle, as disclosed for example in patent application publication US 2019/0255941 A1, are also known. This provides the advantage that, primarily in utility vehicles, the fuel tanks can be accommodated in a space-saving manner at the rear of the driver's cab. In the embodiment disclosed therein, the fuel tanks are fastened by a fastening device which in each case acts on the boss. Such a fastening, however, has the drawbacks, among other things, that firstly it is more complex and secondly it is very stiff. Thus it is not possible to compensate in a simple manner for vibrations and shocks.

### SUMMARY OF THE INVENTION

It is accordingly an object of the invention to provide a fuel tank which overcomes the above-mentioned and other disadvantages of the heretofore-known devices and methods of this general type and which provides for a fuel tank with a fastening device which is better suited for installation in the vehicle, and where the fuel tank ensures secure and reliable fastening.

With the above and other objects in view there is provided, in accordance with the invention, a fuel tank for storing a gas and for installation in a gas-powered vehicle, the fuel tank comprising:
a fuel tank body having an elongate shape with a cylindrical central region and curved pole caps closing both ends thereof, a reinforcing layer made of fiber-reinforced plastic, and a boss on each of said pole caps;
at least two fastening devices embracing said cylindrical central part of said fuel tank body with tensioning straps, said at least two fastening devices being configured for fastening the fuel tank to a support structure;
at least one bead formed on an outer side of said cylindrical central region and arranged directly adjacent one of said at least two fastening devices and abutting thereagainst, said at least one bead being configured to prevent the fuel tank from slipping through said tensioning strap of said one fastening device in one direction.

In other words, the objects of the invention are achieved by a fuel tank which has, in the cylindrical central region on the outer side thereof at least one bead which is arranged directly adjacent to one of the fastening devices and abuts thereagainst and is designed such that the fuel tank is unable to slip through the tensioning straps of the one fastening device at least in one direction. Here, the “one direction” is parallel to the longitudinal direction of the tank.

The particular advantage of the embodiment according to the invention is that a secure and vibration-damping fastening is thus present, without it being necessary to tighten the tensioning straps too tightly. The security against slipping through is thus implemented by the bead. This prevents damage to the reinforcing layer by tensioning straps which are tightened too tightly.

As a further advantage, the fuel tank provides a defined positioning for the installation of the fastening devices.

In addition, an improved vertical installation of the fuel tank in the vehicle is possible. In particular in the case of vertical installation, just one bead is sufficient.

The tensioning straps of the fastening device are designed, in particular, as simple clamps or as so-called hinge strap clamps.

The bead is regarded as a local elevation which represents a larger circumference than the diameter of the cylindrical central region of the fuel tank. As a result of the embodiment as a bead, a smaller quantity of material is required than when, for example, the entire cylindrical central part has a larger diameter and then the tensioning straps, for example, are placed into a recessed groove in order to prevent slipping through. A groove in the reinforcing layer can also reduce the strength of the fuel tank due to notch effects.

The fact that the bead abuts against the fastening device means that no undesirable movement of the fuel tank, which is relevant to safety, is possible through the tensioning straps of the fastening device in a direction parallel to the tank longitudinal direction t. This prevents a displacement of the fuel tank during operation by acceleration forces, as occur in brakes, by vibrations or by longitudinal expansion due to changes in the internal pressure on at least one fastening device. In particular in the case of horizontally installed side tanks, high forces occur in the tank longitudinal direction t when the vehicle brakes. In this case, the bead can preferably be arranged such that it can absorb these forces and prevent the fuel tank slipping through to the front. A displacement of the fuel tank causes undesirable forces on the connections and lines which are connected to the fuel tank. In addition, frequent displacements relative to the tensioning straps can cause damage to the surface of the reinforcing layer.

Additionally, this embodiment provides the advantage for the installation that the positioning of the fuel tank relative to the fastening device is clear and thus the installation of the connecting lines is simplified.

The advantages can be particularly well exploited when the bead is arranged directly adjacent to the fastening device which is arranged closer to the boss which is provided to receive the tank fitting. This makes it possible to avoid undesirable stress on the tank fitting and the connected lines due to the displacement or expansion of the fuel tank. Moreover, the positioning during installation relative to the connecting lines is simpler.

Moreover, it can be advantageous to provide a second bead which is arranged adjacent to the second fastening device in the cylindrical central region on the outer face, wherein the beads abut against the respective fastening devices and are designed such that the fuel tank cannot slip through the tensioning strap(s) of the fastening devices in both directions parallel to the tank longitudinal direction. This is particularly advantageous primarily for a horizontal installation in the vehicle.

Moreover, it is advantageous if the second of the two fastening devices is designed to be resilient and/or displaceable such that the fuel tank can expand in the tank longitudinal direction. This can reduce an undesirable transverse load on the upper fastening device. In particular, the second fastening device is that which is further removed from the boss which is provided to receive the tank fitting.

While in the vertically installed fuel tank the weight force opposes the upward displacement and thus no securing is required in this direction, in the case of horizontal installation it can be advantageous to prevent slipping through in both directions by means of one respective bead.

In a further preferred embodiment, the bead is configured to be annular and surrounds the fuel tank over its entire circumference.

In an alternative preferred embodiment, the bead is configured as one or more annular segments which at least partially surround the fuel tank over its circumference, whereby the annular segments together preferably surround at least 20%, particularly preferably at least 40%, of the circumference.

In each of these cases, the bead is sufficient to prevent slipping through, at least in one direction.

The bead in cross section can represent, for example, a part of a circle or an ellipse or it can be configured to be rectangular.

The height of the bead is the dimension of how far the bead protrudes over the diameter of the cylindrical central part. In terms of height, the bead can preferably be at least 10 mm, particularly preferably at least 20 mm. In particular, the height can be at least 2% of the diameter of the fuel tank in the cylindrical central region. The slipping through can be reliably prevented by one of these embodiments.

The expansion of the bead in the tank longitudinal direction on the connecting surface to the reinforcing layer can preferably be between 20 mm and 80 mm. This provides a sufficient stability and a sufficient connection to the reinforcing layer.

Advantageously, the bead can be produced from a material which is different from the reinforcing layer. Thus it is possible to use a material which is particularly wear-resistant or simpler to process. For example, the bead can be manufactured from metal, from plastic, from rubber or from composite material. The bead can also consist of a combination of materials.

In particular, the bead can be fastened to the outer face of the fuel tank after the reinforcing layer has been produced. Thus the bead can be adhesively bonded or vulcanized thereon, for example. Alternatively, the bead can also be pressed on or clamped on. Alternatively, the bead can be secured against slipping along the fuel tank surface by a positive connection on the outer face of the reinforcing layer.

In a further advantageous embodiment, the bead can be produced as an integral component of the reinforcing layer from fiber-reinforced plastic. Thus during the manufacture of the reinforcing layer the bead is directly produced therewith. For example, this is because after the reinforcing layer has been wrapped around, the bead is also wrapped therewith around the outer face before the resin of the reinforcing layer is cured. This provides a particularly good connection of the bead with the reinforcing layer.

In order to improve the protection of the bead against wear, a metallic element can be provided between the bead and the tensioning straps of the fastening device. In particular with a bead made of plastic or rubber, this provides a longer service life of the bead. The metallic element can be, for example, a sheet metal strip which is adhesively bonded or vulcanized to the side of the bead which comes into contact with the fastening device. Alternatively, it can be designed as a metallic coating.

In a particularly preferred embodiment, the fuel tank is designed such that it is provided for vertical installation in a gas-powered vehicle, in particular a utility vehicle, wherein the bead is arranged directly above one of the two fastening devices. The fact that the bead is arranged above the one fastening device refers to the position in the installed state in the vehicle.

Particularly preferably, the bead is arranged directly above the lower of the two fastening devices. This is also relative to the position in the installed state in the vehicle. In other words, the two fastening devices are configured as an upper fastening device and as a lower fastening device, relative to the subsequent position in the installed state in the vehicle. As a result, the lower part of the fuel tank is held securely in position. Generally, the connections and lines for the refueling and the controlled gas delivery are located on the lower boss. These components are thus protected from any forces which may arise when the fuel tank expands in terms of its length. An expansion of the fuel tank in terms of its length occurs when the tank internal pressure changes when filling or emptying.

Other features which are considered as characteristic for the invention are set forth in the appended claims.

Although the invention is illustrated and described herein as embodied in a fuel tank for a gas-powered vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic side view of a vehicle with a fuel tank according to the invention;

FIG. 2A is a perspective side view of a fuel tank according to the invention;

FIG. 2B is a sectional view thereof;

FIGS. 3A, 3B, 3C are perspective side views of various embodiments of the bead on the fuel tank according to the invention;

FIGS. 3D, 3E, 3F are sectional views thereof;

FIG. 4 is a perspective view of an exemplary embodiment of a fastening device for a fuel tank;

FIG. 5A is a perspective side view of a further fuel tank according to the invention; and

FIG. 5B is a side perspective view of a further fuel tank according to the invention.

### DETAILED DESCRIPTION OF THE INVENTION

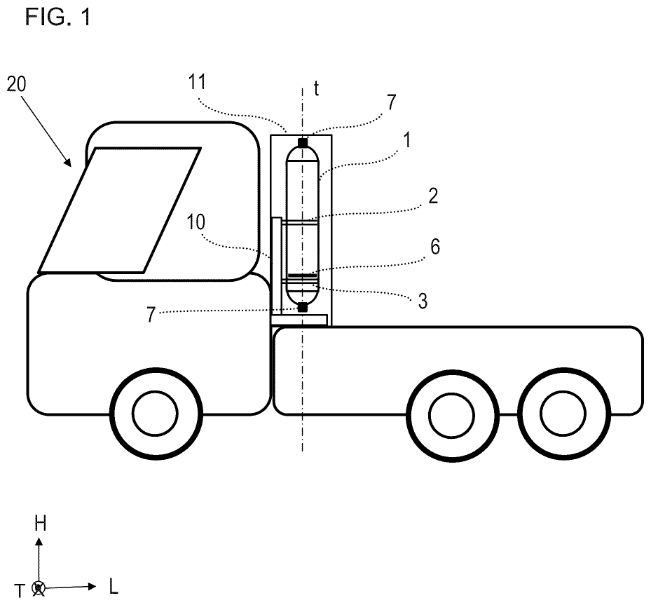

FIG. 1 shows the gas-powered vehicle 20. Preferably, the vehicle 20 is a utility vehicle, for example as shown here a truck or pickup truck. Particularly in gas-powered utility vehicles, large quantities of fuel are required for an economically expedient range. The drive can be implemented, for example, via a fuel cell together with an electric motor or via a gas engine. The fuel may be hydrogen, biogas, methane, ethane, natural, gas or a gas mixture. The gas is stored under pressure in the fuel tank 1. Generally a pressure of at least 200 bar is used, often up to 700 or 875 bar. The vehicle 20 is shown with a fuel tank module which generally has a plurality of fuel tanks 1 which are arranged adjacent one another in the transverse direction T of the vehicle. In this case, the fuel tanks 1 are installed vertically in the vehicle 20, so that the tank longitudinal direction t is oriented substantially parallel to the vertical direction H of the vehicle. This provides an optimal utilization of the installation space, i.e. a maximum possible tank volume with at the same time improved safety, since the tank fittings are well protected on the lower face and are not arranged at the side of the vehicle in the vulnerable region. Depending on the application, the fuel tanks can also be installed horizontally adjacent to the vehicle chassis.

The fuel tank 1 has an elongate shape which is rotationally symmetrical to the tank longitudinal direction t. In the central region, the fuel tank has a cylindrical shape which at both ends is closed by curved pole caps which terminate in a so-called boss 7. Generally a safety valve is provided on the upper boss 7, said safety valve at excessive temperature or excessive pressure expelling the gas and thus relieving pressure from the tank, for example in the case of a fire, in order to avoid an explosion. A tank fitting is present on the lower boss 7. The fuel tank 1 can be filled thereby with gas and gas can be removed thereby during operation in a controlled manner. The tank fittings can optionally comprise additional safety valves.

The fuel tank 1 is provided here with two fastening devices 2, 3 which comprise tensioning straps, for example simple clamps or so-called hinge strap clamps. The upper fastening device 2 and the lower fastening device 3 are present. The fuel tank is fastened to the support structure 10 via both fastening devices 2, 3. Optionally more than two fastening devices can also be used, so that for example a central fastening device is also present.

In the case shown, the support structure 10 also bears the further fuel tanks and serves for the installation of the fuel tank module in the vehicle 20. The support structure can be designed, for example, as a steel frame. The protective cover 11 can be provided for protection against external influences on the fuel tank 1.

The bead 6 on the outer face of the reinforcing layer of the fuel tank 1 abuts against the lower fastening device 3 and according to the invention is used such that the fuel tank 1 cannot slip downwardly through the tensioning straps of the lower fastening device 3. In addition, the bead 6 simplifies the installation, in which it ensures a defined positioning of the fastening device 3 on the fuel tank 1.

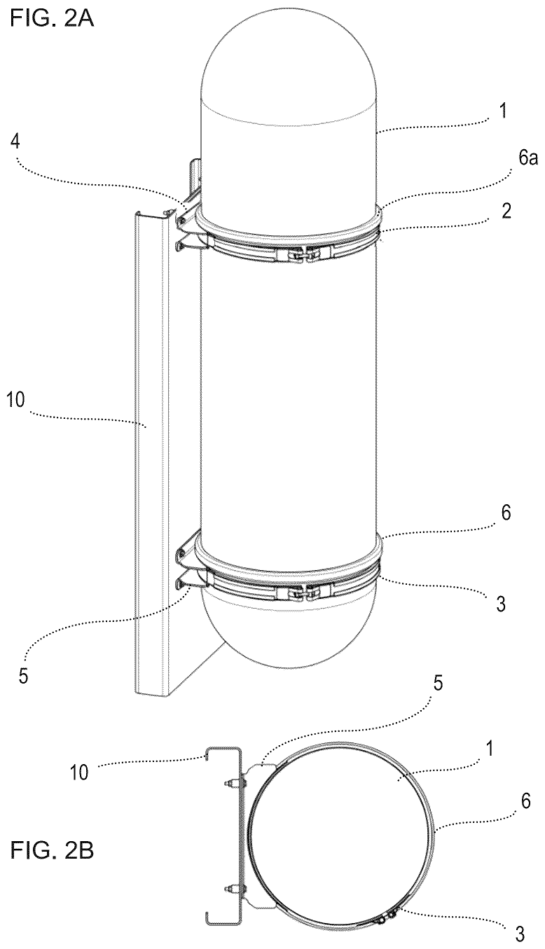

FIGS. 2A and 2B show an embodiment of the fuel tank 1 according to the invention. The fuel tank comprises two fastening devices 2, 3, wherein one is the upper fastening device 2 and one is the lower fastening device 3. Both fastening devices are provided with tensioning straps which encompass the fuel tank over its circumference and which are designed as clamps. In addition, the fastening devices 2, 3 in each case have a base 4, 5 to which the tensioning straps are fastened and against which the fuel tank 1 is clamped. The fuel tank 1 can be fastened to the support structure 10 by means of the fastening devices 2, 3. This support structure 10 serves to install the fuel tank 1 in a vehicle. As shown here, the fuel tank 1 is provided with its fastening devices 2, 3 for vertical installation in a vehicle. The fuel tank 1 has on the outer face a bead 6 which abuts against the lower fastening device 3 and which ensures that the fuel tank 1 does not slip through the tensioning straps of this fastening device 3. Thus the fuel tank is securely held and does not change its position, even in the case of vibrations, which prevents damage to the tank surface.

In the case of fuel tanks 1 which are filled at high pressure, the length of the tank changes according to the internal pressure. Due to the bead 6, the position of the fuel tank 1 relative to the lower fastening device 3 remains fixed. Thus the tank fittings and the lines generally connected to the lower boss are protected from any additional and variable stress due to the longitudinal expansion of the fuel tank 1.

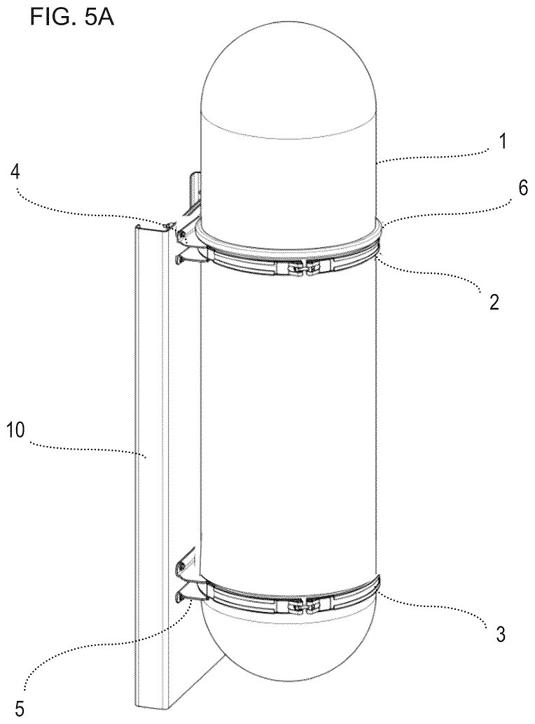

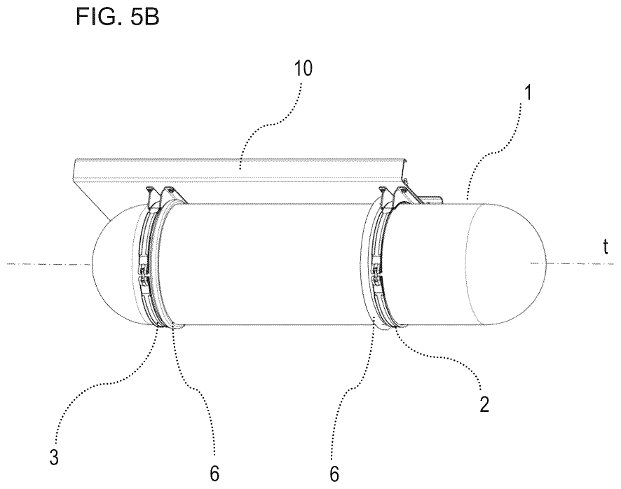

Alternatively, the bead 6 can also be provided above the upper fastening device 2 as shown in FIG. 5A. This is advantageous primarily when the tank fittings are connected to the upper boss. This is because the position of the fuel tank 1 relative to the upper boss remains substantially constant in the case of longitudinal expansion.

In particular, in the case of a horizontal installation of the fuel tank 1 in the vehicle it can be expedient to provide two beads 6 as shown in FIG. 5B. The two beads 6 are arranged such that the fuel tank 1 cannot slip through the tensioning straps in both directions in the tank longitudinal direction t.

Also according to the invention are further embodiments with a plurality of fastening devices, which comprise tensioning straps, and in which the bead abuts against at least one of the fastening devices.

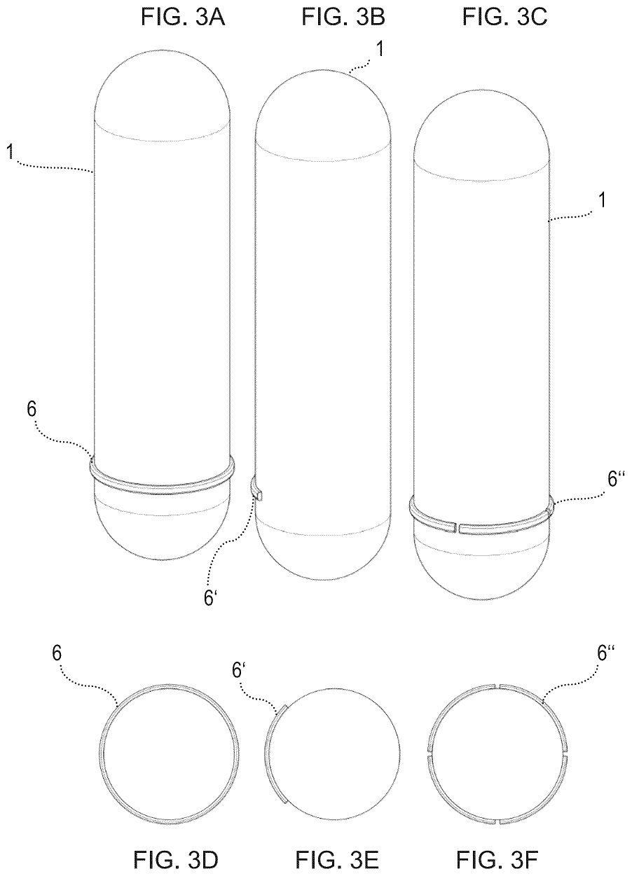

FIGS. 3A, 3B, 3C show three different embodiments of the bead 6, 6′, 6″ irrespective of the position in which the bead 6, 6′, 6″ is provided. The corresponding sectional views are illustrated in FIGS. 3D, 3E, 3F.

In FIGS. 3A and 3D, the bead 6 is configured as a ring over the entire circumference of the fuel tank 1.

Alternatively the bead 6′, as shown in FIGS. 3B and 3E, can be configured simply as an annular segment. Preferably, the bead 6′, as shown here, is attached to at least 20% of the circumference.

In a further variant, the bead 6″ can consist of a plurality of annular segments which are arranged over the circumference of the fuel tank 1. There are, for example, four segments in this case, as illustrated in FIGS. 3C and 3F. A simpler manufacture and fastening of the bead 6″ is possible by dividing the bead 6″ into a plurality of annular segments.

The bead 6, 6′, 6″ can be an integral component of the reinforcing layer or it can be separately produced and fastened to the outer face of the fuel tank 1, as described above. If it is separately produced, the bead 6, 6′, 6″ can consist of a material which is different from the reinforcing layer of the fuel tank 1, for example from metal, from plastic, from rubber or from a composite material. In order to reduce the wear of the bead 6, 6′, 6″ and thus to increase the durability, a metallic element can be provided on the bead 6, 6′, 6″ for protection. This metallic element can be, for example, a sheet metal strip or a metallic coating on the side of the bead which comes into contact with the fastening device 3.

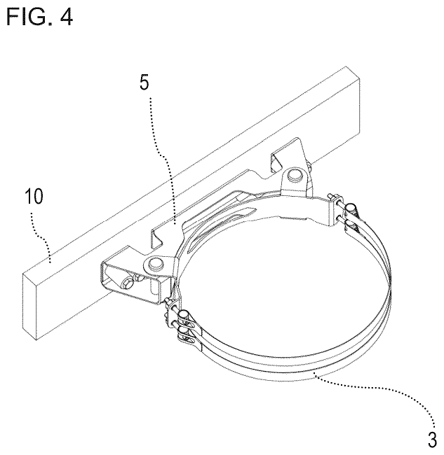

The view in FIG. 4 shows an exemplary variant of the fastening device 3. The fastening device 3 comprises tensioning straps, which are designed here as hinge strap clamps, and a base 5 to which the tensioning straps are fastened. The fuel tank can be fastened to the support structure 10 by means of this fastening device 3.

FIG. 5A is a perspective side view of a further embodiment of a fuel tank according to the invention. In this case, the beads 6 are formed on the outside of the fastening devices 2, 3; that is, the beads 6 “straddle” the fastening devices.

Finally, FIG. 5B is a side perspective view of a further embodiment of a fuel tank according to the invention, mounted in a horizontal orientation. In this case, the beads are formed inside of the fastening devices 2, 3; that is, the fastening devices “straddle” the beads.

The following is a summary list of reference numerals and the corresponding structure used in the above description of the invention:
1 Fuel tank
2 Fastening device
3 Fastening device
4 Bracket
5 Bracket
6, 6′, 6″ Bead
7 Boss
10 Support structure
11 Protective cover
20 Gas-powered utility vehicle
H Vertical direction of vehicle
L Longitudinal direction of vehicle
T Transverse direction of vehicle
t Tank longitudinal direction

1. A fuel tank for storing a gas and for installation in a gas-powered vehicle, the fuel tank comprising:
a fuel tank body having an elongate shape with a cylindrical central region and curved pole caps closing both ends thereof, a reinforcing layer made of fiber-reinforced plastic, and a boss on each of said pole caps;
at least two fastening devices embracing said cylindrical central part of said fuel tank body with tensioning straps, said at least two fastening devices being configured for fastening the fuel tank to a support structure;
at least one bead formed on an outer side of said cylindrical central region and arranged directly adjacent one of said at least two fastening devices and abutting thereagainst, said at least one bead being configured to prevent the fuel tank from slipping through said tensioning strap of said one fastening device in one direction.

2. The fuel tank according to claim 1, wherein said at least one bead is arranged directly adjacent said one fastening device that is arranged closer to said boss which is provided to receive a tank fitting.

3. The fuel tank according to claim 1, wherein a second one of said at least two fastening devices is formed to be at least one of resilient or displaceable to enable the fuel tank to expand in a tank longitudinal direction.

4. The fuel tank according to claim 3, wherein a second bead that is arranged adjacent said second fastening device is present in said cylindrical central region on an outer face thereof, wherein said beads abut against the respective fastening devices and are designed such that the fuel tank cannot slip through said tensioning straps of said fastening devices in two directions.

5. The fuel tank according to claim 1, wherein said at least one bead is an annular bead formed to surround an entire circumference of said fuel tank body.

6. The fuel tank according to claim 1, wherein said at least one bead is formed of one or more annular segments that at least partially surround said fuel tank body over a circumference thereof.

7. The fuel tank according to claim 6, wherein said one or more annular segments together surround at least 20% of the circumference.

8. The fuel tank according to claim 6, wherein said one or more annular segments together surround at least 40% of the circumference.

9. The fuel tank according to claim 1, wherein said at least one bead is produced from a material that is different from a material of said reinforcing layer of the fuel tank.

10. The fuel tank according to claim 1, wherein said at least one bead is formed as an integral component of said reinforcing layer of said fuel tank body.

11. The fuel tank according to claim 1, wherein said at least one bead has been fastened to an outer face of said fuel tank body after the tank wall has been produced.

12. The fuel tank according to claim 11, wherein said at least one bead is adhesively bonded or vulcanized on the fuel tank body.

13. The fuel tank according to claim 11, wherein said at least one bead is pressed on or clamped on.

14. The fuel tank according to claim 1, wherein said at least one bead is positively fastened to an outer face of said fuel tank body.

15. The fuel tank according to claim 1, wherein said at least one bead has a metallic element which is attached to a side thereof that comes into contact with said one fastening device.

16. The fuel tank according to claim 1, wherein said fuel tank body is configured for vertical installation in the gas-powered vehicle and said at least one bead is arranged directly above one of said at least two fastening devices.

17. The fuel tank according to claim 16, wherein said fuel tank body is configured for vertical installation in a gas-powered utility vehicle.

18. The fuel tank according to claim 16, wherein said at least one bead is arranged directly above a lower fastening device of said at least two fastening devices.
